(19) United States
(12) Patent Application Publication
(10) Pub. No.: US 2025/0265305 A1
(43) Pub. Date: Aug. 21, 2025

(54) Method and System for Web Data Extraction Using Meta-Path Graph

(71) Applicant: S&P Global Inc., New York, NY (US)

(72) Inventors: Saeed Shoaraee, Burlington (CA); Akshay Sehgal, Gurugram (IN); Mrinal Gupta, Jammu (IN); Ankur Debnath, Hyderabad (IN)

(21) Appl. No.: 18/444,999

(22) Filed: Feb. 19, 2024

(51) Int. Cl. G06F 16/958; G06F 18/2415

(52) U.S. Cl. CPC G06F 16/986; G06F 18/2415

(57) ABSTRACT

A computer-implemented method for web data extraction is provided. The method includes receiving an HTML file containing HTML data and converting the HTML data into an HTML graph. Elements in the HTML file are represented by nodes in the HTML graph and relationships among the elements are represented by meta-paths. The method includes generating feature sets for the nodes in the HTML graph and identifying areas of interest in the HTML graph based on the feature sets of the nodes. The method includes refining the identified areas of interest by segregating sub-structures having recurring patterns or sequences. The method includes extracting data items from the segregated sub-structures, storing the extracted data items and monitoring them over time for any significant updates.

### BACKGROUND INFORMATION

### 1. Field

The present disclosure relates generally to web data extraction, and more specifically to a method and system for web data extraction using meta-path graphs.

### 2. Background

Conventional web data extraction methods have limitations and challenges. Current methods of extracting web data from HTML documents predominantly rely on predefined templates, fixed pointers or rigid rules. These approaches suffer from scalability issues, requiring substantial maintenance overhead to set up and manage crawlers through manual feature engineering and logic definition.

Due to the forgiving nature of HTML syntax that allows variations and shortcuts while designing an HTML document, extracting data from HTML documents can pose additional challenges. These variations in HTML syntax can lead to several drawbacks when trying to extract data. Some of the drawbacks are ambiguity in structure, parsing errors, inconsistent data extraction and difficulty in identifying elements.

Furthermore, conventional web data extraction methods often fail to discriminate between relevant changes on web pages crucial for organizational use cases and inconsequential alterations resulting from page geometry modifications or noise.

### SUMMARY

An illustrative embodiment provides a computer-implemented method for web data extraction. The method comprises receiving an HTML file containing HTML data and converting the HTML data into an HTML graph. Elements in the HTML file are represented by nodes in the HTML graph and relationships among the elements are represented by meta-paths. The method comprises generating feature sets for the nodes in the HTML graph. The method comprises identifying areas of interest in the HTML graph based on the feature sets of the nodes. The method comprises refining the identified areas of interest by segregating sub-structures having recurring patterns or sequences. The method comprises extracting data items from the segregated sub-structures and storing the extracted data items.

In an illustrative embodiment, the feature sets are represented by vectors. The vectors include one or more of: location or position vectors; content vectors; property features; and domain specific vectors.

In an illustrative embodiment, the method comprises detecting changes to web pages by detecting changes to the extracted data items from the segregated sub-structures, wherein the changes to the web pages are modifications or updates to the web pages. The extracted data items are standardized and stored as one or more of: key-value pairs; tabular content; and pagination.

In an illustrative embodiment, the method comprises determining if the changes to web pages are significant changes. If there are significant changes, users are notified via a user interface.

In an illustrative embodiment, the method comprises training a machine learning model using the significant changes to form a trained model object and segregating the sub-structures using the trained model object.

Another illustrative embodiment provides a system for web data extraction. The system comprises a storage device configured to store program instructions. The system comprises one or more processors operably connected to the storage device and configured to execute the program instructions to cause the system to: receive an HTML file containing HTML data; convert the HTML data into an HTML graph, wherein elements in the HTML file are represented by nodes in the HTML graph and relationships among the elements are represented by meta-paths; generate feature sets for the nodes in the HTML graph; identify areas of interest in the HTML graph based on the feature sets of the nodes; refine the identified areas of interest by segregating sub-structures having recurring patterns or sequences; and extract data items from the segregated sub-structures and store the extracted data items.

Another illustrative embodiment provides a computer program product for web data extraction. The computer program product comprises a computer-readable storage medium having program instructions embodied thereon to perform the steps of: receiving an HTML file containing HTML data; converting the HTML data into an HTML graph, wherein elements in the HTML file are represented by nodes in the HTML graph and relationships among the elements are represented by meta-paths; generating feature sets for the nodes in the HTML graph; identifying areas of interest in the HTML graph based on the feature sets of the nodes; refining the identified areas of interest by segregating sub-structures having recurring patterns or sequences; and extracting data items from the segregated sub-structures and storing the extracted data items.

### BRIEF DESCRIPTION OF THE DRAWINGS

The novel features believed characteristic of the illustrative embodiments are set forth in the appended claims. The illustrative embodiments will best be understood by reference to the following detailed description of the illustrative embodiments of the present disclosure when read in conjunction with the accompanying drawings, wherein:

FIG. 1 illustrates a network of data processing system in accordance with an illustrative embodiment;

FIG. 2 is a block diagram of a system for web data extraction in accordance with an illustrative embodiment;

FIG. 3 illustrates a system for web data extraction in accordance with an illustrative embodiment;

FIG. 4 illustrates web data extraction by constructing an HTML graph in accordance with an illustrative embodiment;

FIGS. 5A and 5B illustrate an example web data extraction in accordance with illustrative embodiments;

FIGS. 6A and 6B illustrate another example web data extraction in accordance with illustrative embodiments;

FIGS. 7A and 7B illustrate another example web data extraction in accordance with illustrative embodiments;

FIGS. 8A, 8B, 9A, 9B and 10 illustrate user interfaces showing data extracted from web pages and detection of significant changes;

FIG. 11 illustrates a flowchart of a process for web data extraction in accordance with an illustrative embodiment;

FIG. 12 illustrates a flowchart of a process for detecting changes or updates to web pages in accordance with an illustrative embodiment; and

FIG. 13 illustrates a block diagram of a data processing system in accordance with an illustrative embodiment.

### DETAILED DESCRIPTION

The illustrative embodiments address limitations of conventional web data extraction methods and systems. The illustrative embodiments provide a method and system for web data extraction using a meta-path graph data model.

In an illustrative embodiment, an HTML file is received. The HTML file contains raw HTML data. An HTML graph extractor converts the raw HTML data into an HTML graph. Each HTML element in the graph is represented by a node, and relationships among the elements are represented by meta-paths (e.g., edges or connections), thus illustrating parent-child relationships in the graph.

A feature extractor creates a feature set for each node in the graph. The feature set may be represented by vectors which may include: (1) location/position vectors (e.g., coordinates or relative positions); (2) content vectors (e.g., embeddings representing text content); and (3) property vectors (e.g., attributes from HTML/CSS).

Based on the feature sets, an area of interest (AOI) identifier detects or identifies specific regions, sub-graphs, sub-structures or nodes within the HTML graph (or DOM-Document Object Model) that are of interest to a specific organization or an entity. The specific regions, sub-graphs or sub-structures may include headers, footers, menus, tables, main content, sidebars, etc. The AOI identifier filters out non-relevant nodes. The non-relevant nodes are considered not of interest to the specific organization or entity.

A sub-structure analyzer refines the identified areas of interest using meta-path based models. The sub-structure analyzer identifies recurring patterns or sequences of nodes and relationships, helping to understand the structural patterns or sequences within the HTML graph. These patterns are recorded (for example, in a database) and correlated to data items for subsequent steps in the process. During inference, the sub-structure analyzer refers to this history to segregate or isolate reoccurring patterns.

A data extractor extracts data items from the refined areas of interest. The extracted data items are standardized and stored. The extracted values can be stored, for example, as key-value pairs, tabular content (e.g., headers, table, footers) and pagination (e.g., URLs). The extracted values may suggest additional data based on learned patterns or user-defined rules.

In some embodiments, changes to the web pages are detected. The changes to the web pages can be detected from the changes to segregated or isolated sub-structures in the HTML graph or can be detected from the changes in the extracted data items.

If changes to the web pages are determined to be significant, users are automatically notified via a user interface for feedback on the changes.

In some embodiments, using the changed sub-structures, a machine learning model is trained to form a new model object. The trained model object represents a mapping function which makes predictions or decisions on new or unseen sub-structures or data in the HTML graph.

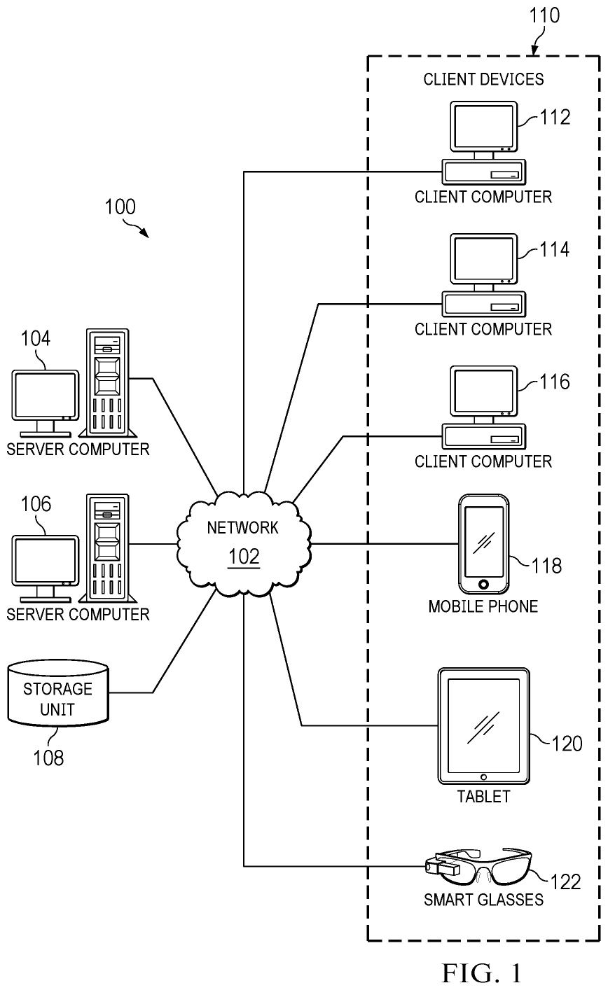

With reference to FIG. 1, a pictorial representation of a network of data processing system is depicted in which illustrative embodiments may be implemented. Network data processing system 100 is a network of computers in which the illustrative embodiments may be implemented. Network data processing system 100 contains network 102, which is the medium used to provide communications links between various devices and computers connected within network data processing system 100. Network 102 may include connections, such as wire, wireless communication links, or fiber optic cables.

In the depicted example, server computers 104 and 106 and storage unit 108 connect to network 102. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In the illustrative example of FIG. 1, server computers 104 and 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Program code located in network data processing system 100 can be stored on a computer-recordable storage medium and downloaded to a data processing system or other device for use. For example, the program code can be stored on a computer-recordable storage medium on server computers 104 and 106 and storage unit 108 and downloaded to client devices 110 over network 102 for use on client devices 110.

In the illustrative example of FIG. 1, network 102 can be the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using different types of networks. For example, network 102 can be comprised an intranet, a local area network (LAN), a metropolitan area network (MAN), or a wide area network (WAN). FIG. 1 is intended as an example, and not as an architectural limitation for the different illustrative embodiments.

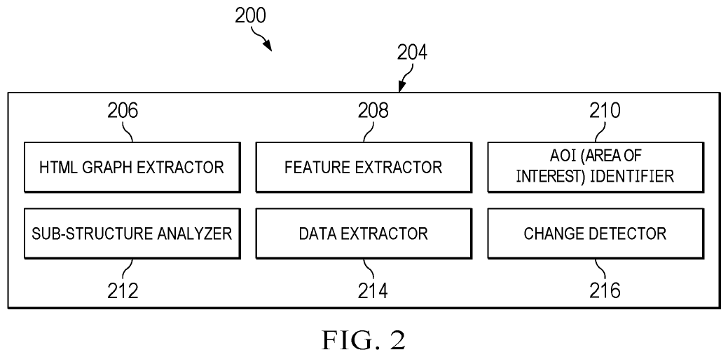

FIG. 2 is a block diagram of system 200 for web data extraction in accordance with an illustrative embodiment. System 200 comprises computer system 204. Computer system 204 is a physical hardware system which includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system. System 200 can be implemented, for example, in server computers 104 and 106 or may be implemented in client devices 110.

Computer system 204 includes HTML graph extractor 206. HTML graph extractor 206 converts raw HTML data into a graph representation. In an illustrative embodiment, the graph extractor converts raw HTML data into an HTML graph (e.g., heterogenous graph). Each HTML element (e.g., tag) in the graph is represented by a node, and relationships among the elements are represented by meta-paths (e.g., edges or connections).

Computer system 204 includes feature extractor 208. Feature extractor 208 creates a feature set for each node in the HTML graph. The feature set may be represented by vectors which include: (1) location/position features (e.g., coordinates or relative positions); (2) content features (e.g., embeddings representing text content); and (3) property features (e.g., attributes from HTML/CSS).

Computer system 204 includes area of interest (AOI) identifier 210 configured to identify specific regions, sub-structures or nodes within the HTML graph that are of interest to a specific organization or entity. The specific regions or sub-structures may be identified from the feature sets created by feature extractor 208. The specific regions or sub-structures may include headers, menus, tables, main content, sidebars, etc. AOI identifier 210 filters out non-relevant nodes. The non-relevant nodes are considered not of interest to the specific organization or entity.

Computer system 204 includes sub-structure analyzer 212 configured to refine the identified areas of interest further using meta-path based models. Sub-structure analyzer 212 identifies patterns or sequences of node types and relationships, helping to understand the recurring structural patterns within the HTML graph. Sub-structure analyzer 212 segregates or isolates sub-structures having patterns or sequences.

Computer system 204 includes data extractor 214 which prioritizes and extracts data items from the refined areas of interest. The extracted data items are standardized and stored. The extracted data items can be stored, for example, as key-value pairs, tabular content (e.g., headers, table, footers) and pagination (e.g., URLs). The extracted data items may suggest additional data based on learned patterns or user-defined rules.

In some embodiments, computer system 204 includes change detector 216 configured to detect changes to the web pages. The changes may be defined as any modifications or updates to the web pages. For example, any modifications or changes in contents, data items, text, tables, headers, footers, etc., may be considered as changes to the web pages. The changes to the web pages can be detected from changes to the segregated or isolated sub-structures or changes to the extracted data items.

If significant changes to the web pages are detected, users are alerted through a user interface for feedback on the changes. Significant changes may be defined as changes that are considered crucial for organizational use cases. For example, if a web page publishes current mortgage interest rates or asset values of investment funds, changes in the mortgage interest rates or changes in the asset values may be considered significant changes. In contrast, insignificant changes may be defined as inconsequential alterations resulting from page geometry modifications or noise.

Using the new sub-structures, a machine learning model can be trained to form a new trained model object. The trained model object represents a mapping function which makes predictions or decisions on new or unseen sub-structures or data in the HTML graph.

In some example embodiments, various components of computer system 204 can be implemented in software, hardware, firmware of one or more combinations of software, hardware or firmware.

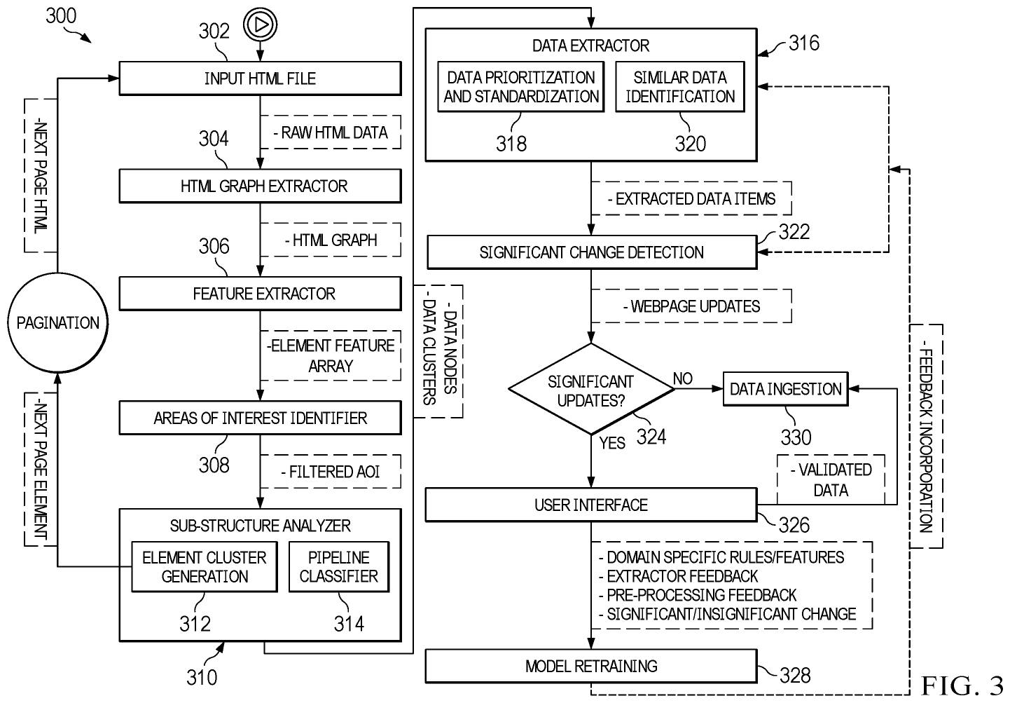

FIG. 3 illustrates system 300 for web data extraction in accordance with an illustrative embodiment. Initially, HTML file 302 which contains raw data is received. Next, graph extractor 304 converts the raw data of HTML file 302 into a graph representation. Graph extractor 304 parses raw HTML data and generates a network graph of HTML nodes (e.g., heterogenous graph). In the HTML graph, each HTML element (e.g., tags, headers, footers, tables, other content) is represented by a node, and relationships among the elements are represented by meta-paths (e.g., edges or connections), thus illustrating parent-child relationships in the graph.

Next, feature extractor 306 extracts an array of features from each node in the graph. The feature set may be represented by vectors which may include: (1) location/position vectors which capture element hierarchy and relation to other elements (e.g., coordinates or relative positions); (2) content vectors which capture content of tags (e.g., embeddings representing text content); (3) property vectors which provide information about tags, tag metadata, CSS attributes, etc.; (4) domain specific vectors which provide project specific features.

Next, area of interest (AOI) identifier 308 identifies specific regions, sub-structures or nodes within the HTML graph that are of interest to a specific organization. Area of interest identifier 308 uses information from the feature vectors and input from users to infer most probable regions, sub-structures or nodes of interest in the graph. For example, an organization may be interested in mortgage rates or certificate of deposit (CD) rates which are published on a web page. AOI identifier 308 identifies regions, sub-structures or nodes within the HTML graph that contain tags, headers, footers, tables and other content related to the subject matter of interest. AOI identifier 308 filters out non-relevant regions, sub-structures or nodes which are not of interest to the organization. AOI identifier 308 also classifies meta-data associated with identified areas of interest.

Sub-structure analyzer 310 refines the identified areas of interest further using meta-path based models. Sub-structure analyzer 310 identifies recurring patterns or sequences of sub-structures or node-types and relationships, helping to understand the structural patterns or sequences within the HTML graph.

In an illustrative embodiment, sub-structure analyzer 310 includes meta-path cluster generator 312 that generates element clusters which are then segregated or isolated to identify different content types. This segregation is done using the feature vectors and can represent collections of different content types. For example, element clusters may include collections of key-value pairs, tabular contents and paginations. Sub-structure analyzer 310 includes pipeline classifier 314 which classifies isolated clusters by content types.

Next, data extractor 316 extracts data items from the segregated or isolated sub-structures or clusters. The extracted data is prioritized based on their confidence metrices. Data extractor 316 includes data prioritization and/or standardization module 318 that prioritizes extracted data items based on relevance or importance to the specific organization. The extracted data items are standardized and stored, for example, as key-value pairs, tabular content (e.g., headers, table, footers) and pagination (e.g., URLs). Data extractor 316 includes similar data identifier 320 which identifies patterns or sequences with sub-structures similar to the extracted data items based on the clusters generated by cluster generator 312. The patterns or sequences may be used to detect additional data based on learned patterns or user-defined rules.

In some embodiments, change detector 322 identifies significant changes and updates to the web pages based on user defined logic and feedback. The changes or updates to the web pages may result in changes to one or more segregated or isolated sub-structures in the HTML graph.

In some embodiments, change detector 322 detects changes or updates to the web pages by detecting changes or updates to the segregated or isolated sub-structures. In some embodiments, change detector 322 detects changes or updates to the web pages by detecting changes of updates in the extracted and stored data items.

Because the segregated or isolated sub-structures are identified as areas of interest, by detecting changes or updates to the segregated sub-structures, relevant or important changes or updates to the web pages are identified. Similarly, because stored data items are extracted from feature vectors of the segregated or isolated sub-structures and stored in a standardized format (e.g., table), by detecting changes or updates in the stored data items, relevant or important changes or updates to the web pages are identified.

For example, by analyzing the same sub-structure at two different dates, relevant or important changes to the web pages can be detected. A sub-structure S1 may be analyzed on Jun. 1, 2023 and thereafter on Jul. 1, 2023. By detecting changes or differences between the sub-structure S1 as it existed on Jul. 1, 2023 and the sub-structure S1 as it existed on Jun. 1, 2023, changes to the web pages can be detected.

Similarly, by detecting the changes or differences in a table TI containing extracted data items associated with the sub-structure S1 on Jun. 1, 2023 and the table TI on Jul. 1, 2023, relevant and important changes to the web pages can be detected.

Thus, instead of monitoring entire web pages to detect changes, specific regions or sub-structures that are areas of interest are monitored. The effect of this is that reduced processing resource and maintenance overhead are required to detect changes to the web pages. Furthermore, because only specific regions or sub-structures of interest are monitored for changes, only those changes that are relevant or important to an organization or entity are identified. As such, processing resources are not wasted on identifying changes to the web pages that may not be important to an organization or an entity.

In contrast, existing change detection methods monitor entire web pages by setting up crawlers which check each element in the web pages. As such, existing change detection methods require significant processing resource and high maintenance overhead. Furthermore, existing change detection methods frequently fail to distinguish between changes that are relevant or important an organization or an entity from those changes that are not of significance.

Referring again to FIG. 3, in decision block 324, if changes or updates to the web pages are determined to be significant, users are alerted via user interface 326 for feedback on the changes, and the changes and updates are stored in database 330. Based on user feedback, machine learning model 328 can be trained to form a new trained model object. The trained model object represents a mapping function which makes predictions or decisions on new or unseen sub-structures or data in the HTML graph. The trained model object is used by data extractor for similar data identification and extraction. If there are no significant changes or updates present, the data is stored in database 330.

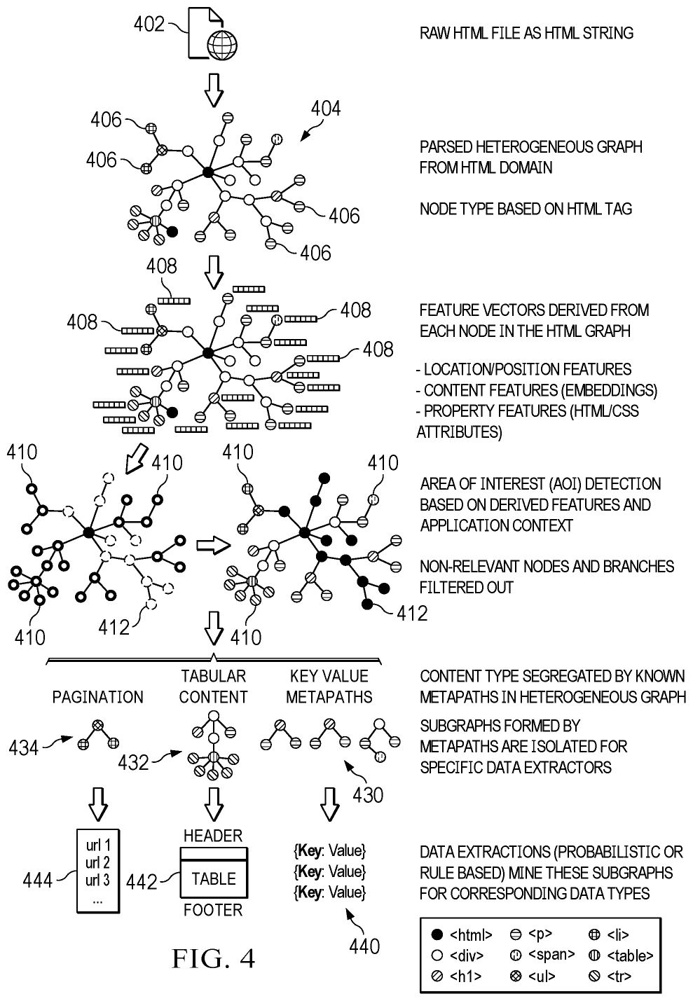

FIG. 4 illustrates web data extraction from an HTML file by constructing an HTML graph in accordance with an illustrative embodiment. Initially, HTML file 402 is received. HTML graph extractor 304 converts HTML file 402 into HTML graph 404. In HTML graph 404, nodes 406, which are illustrated as circles, represent tags and contents of HTML file 402. For example, nodes 406 may represent one of the following tags:
<html>: html;
<div>: division;
<h1>: header;
<p>: paragraph;
<span>: span;
<ul>: list;
<li>: list item;
<table>: table;
<tr>: table row.

Feature extractor 306 creates feature set 408 for each node 406 in the HTML graph. Feature set 408 may be represented by vectors which may include: (1) location/position vectors (e.g., coordinates or relative positions); (2) content vectors (e.g., embeddings representing text content); and (3) property vectors (e.g., attributes from HTML/CSS).

In some embodiments, feature extractor 306 creates expressive features from the nodes and tags of the HTML graph. Feature extractor 306 is configured to capture information from text and domain in the graph, which are crucial for subsequent processes. In some embodiments, the feature extraction process starts with the parsing of the heterogeneous graph. The location/position vectors capture information of a node's position in the context of its ancestors, child nodes and descendants. The content vectors are encoded representations of text created using embeddings to capture the semantics of content present in the nodes. The property vectors capture an array of f attributes related to tag information, CSS and text features from tag parameters. The domain specific vectors such as content type, content length, specific Booleans further augment the information present at each node.

Area of interest (AOI) identifier 308 analyzes feature set 408 which are represented by vectors. Based on the analysis, AOI identifier 308 identifies specific regions, sub-structures or nodes 410 within the HTML graph that are of interest to a specific organization or an entity. For example, an organization may be interested in mortgage rates, certificate of deposit (CD) interest rates or commodity prices which are published on a web page. The AOI identifier identifies regions, sub-structures or nodes 410 within the HTML graph that contain tags, headers, footers, tables and other content related to the subject matter of interest. The AOI identifier filters out non-relevant regions, sub-structures or nodes 412. Non-relevant regions or nodes 412 are considered not of interest to the organization or entity. Non-relevant nodes 412 are illustrated as solid dark circles.

In some embodiments, AOI identifier 308 uses ensemble classification models to categorize and rank relevant and irrelevant nodes in the graph. AOI identifier 308 extracts a latent representation of the multi-fold features along with the input application context which are used to identify corresponding regions, sub-structures or nodes of interest for the data items.

Next, sub-structure analyzer 310 refines the identified areas of interest further using meta-path based models. The sub-structure analyzer identifies recurring patterns or sequences of node-types and relationships, helping to understand the structural patterns or sequences within the HTML graph. In an illustrative embodiment, the sub-structure analyzer generates element clusters which are segregated or isolated by content types. For example, element clusters may be segregated by key-value pairs (e.g., 430), tabular contents (e.g., 432) and paginations (e.g., 434).

In some embodiments, identified areas of interests are further processed to identify and rank subgraphs within the areas of interest. Sub-structure analyzer 310 builds ensemble models on known meta-paths and uses these models to find and rank most similar subgraphs or sub-structures to be passed on to specific extraction modules for subsequent data extraction process.

Next, data extractor 316 prioritizes and extracts data items from the isolated sub-structures or clusters. The extracted data items are standardized and stored, for example, as key-value pairs 440, tabular content 442 (e.g., headers, table, footers) and pagination 444 (e.g., URLs).

In some embodiments, change detector 322 identifies changes to the web pages by monitoring changes to the segregated or isolated sub-graphs 430, 432 and 434. Also, changes to the web pages are identified by monitoring changes or updates to the stored data items 440, 442 and 444. If changes to the web pages are determined to require significant updates to the stored data items, users are alerted via a user interface for feedback on the changes. Based on user feedback, a machine learning model is trained to form a new trained model object. The trained model object represents a mapping function which makes predictions or decisions on new or unseen sub-structures or data in the HTML graph. The trained model object is used by data extractor for similar data identification and extraction.

Thus, instead of monitoring entire web pages to detect changes, specific regions or sub-structures that are areas of interest are monitored for any changes. According to other embodiments, segregated sub-graphs are monitored for any changes to the web pages. The effect of this is that reduced processing resource and maintenance overhead are required to detect changes to the web pages. Furthermore, because only specific regions or sub-structures of interest and segregated data items are monitored for changes, only those changes that are relevant or important to an organization or an entity are identified. As such, processing resources are not wasted on identifying changes to the web pages that may not be important to an organization or an entity.

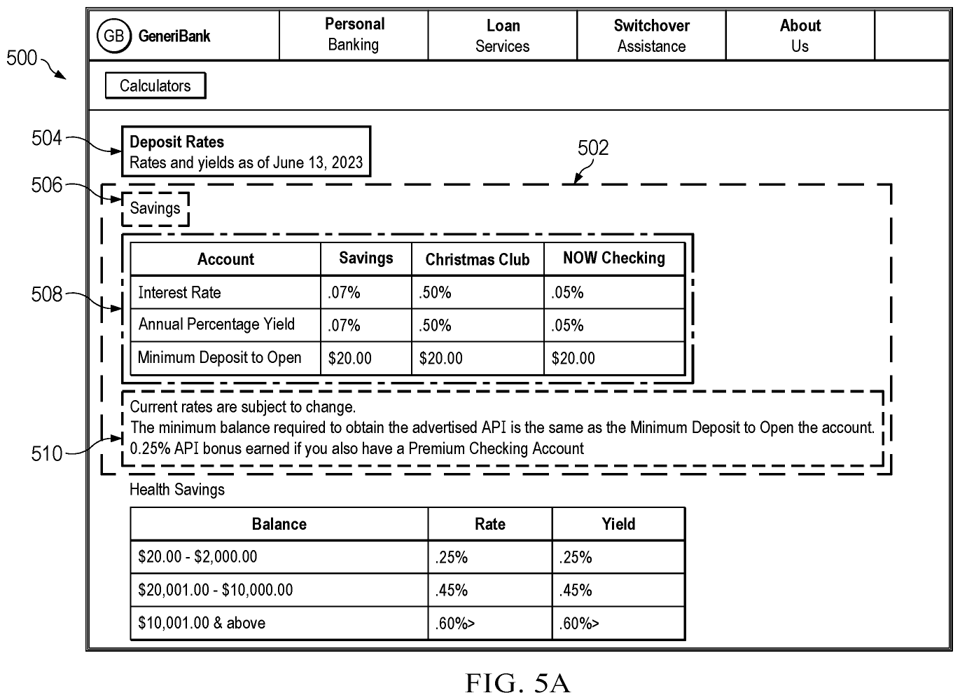

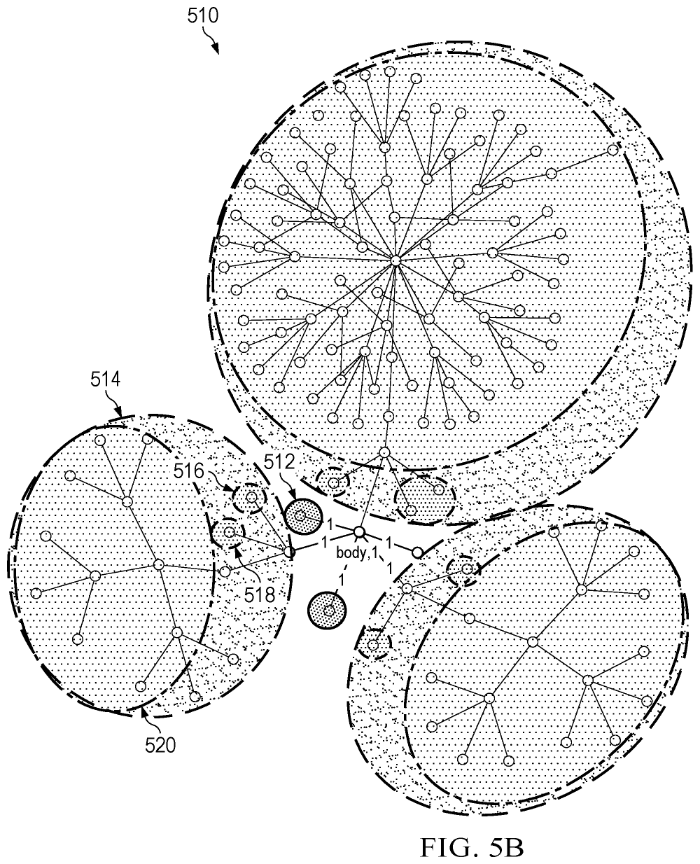

FIGS. 5A and 5B illustrate an example web data extraction in accordance with illustrative embodiments. In FIG. 5A, web page 500 provides deposit rate information which is identified as areas of interest. Web page 500 displays table 502 which includes title 504, header 506, table contents 508 and footer 510.

FIG. 5B shows corresponding graph 510 of table 502. Graph 510 is broken into sub-graphs and meta-paths showing relationships among sub-graphs and nodes. Sub-graph 514 represents table 502. Inside sub-graph 514, node 516 represents header 506, node 518 represents footer 510, and sub-graph 520 represents table contents 508. These areas of interest are passed on for sub-structure analysis and data extraction.

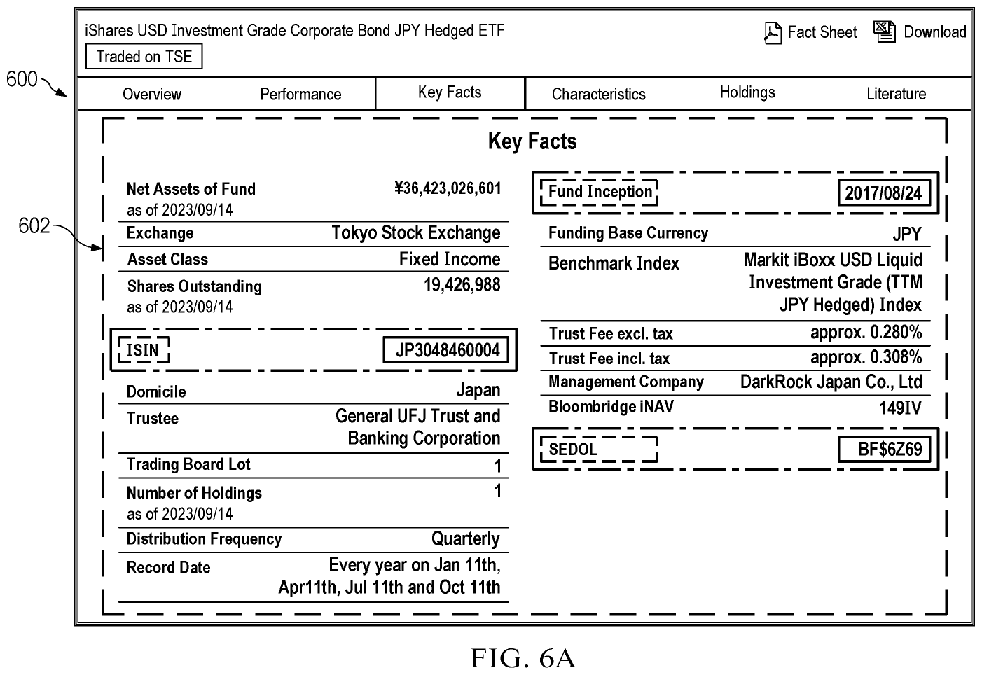

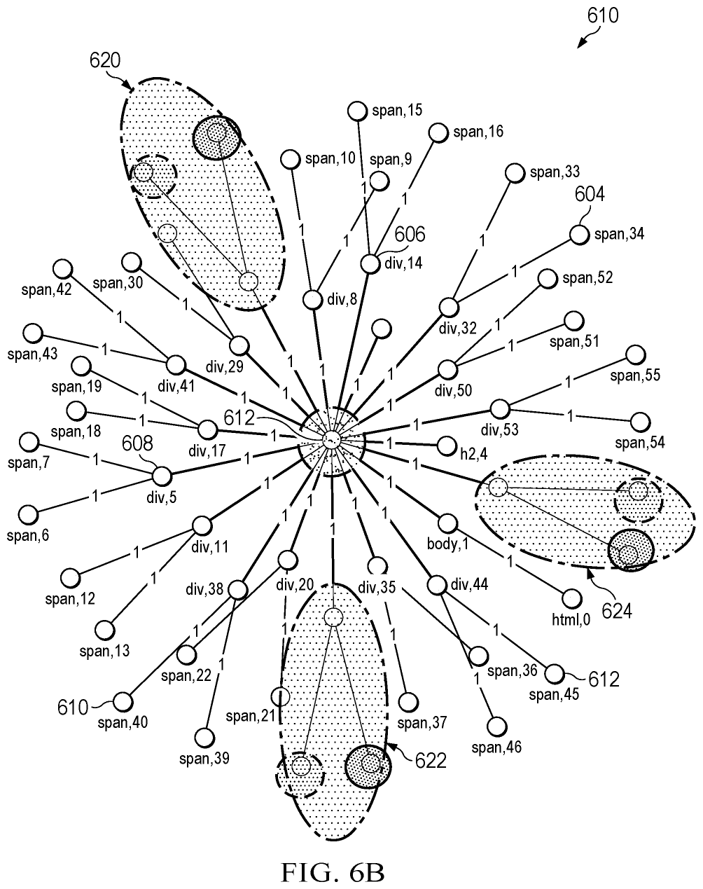

FIGS. 6A and 6B illustrate an example web data extraction in accordance with illustrative embodiments. FIG. 6A shows web page 600 which provides information about an investment fund (“iShares Investment Fund”). This information is indicated as “Key Facts” in box 602.

FIG. 6B shows corresponding graph 610 of the contents of box 602. In graph 610, contents of box 602 are shown by a plurality of nodes. Root node 612 (division tag) represents box 602. Other nodes 604, 606, 608, 612, which are span tags or division tags, represent other elements inside box 602. In some embodiments, data extraction models are used to extract key-value pairs in sub-graphs 620, 622 and 624. Sub-graphs 620, 622 and 624 have similar structures because they represent rows in box 602. As such, these sub-graphs can be used to extract similar data items from other areas of graph 610.

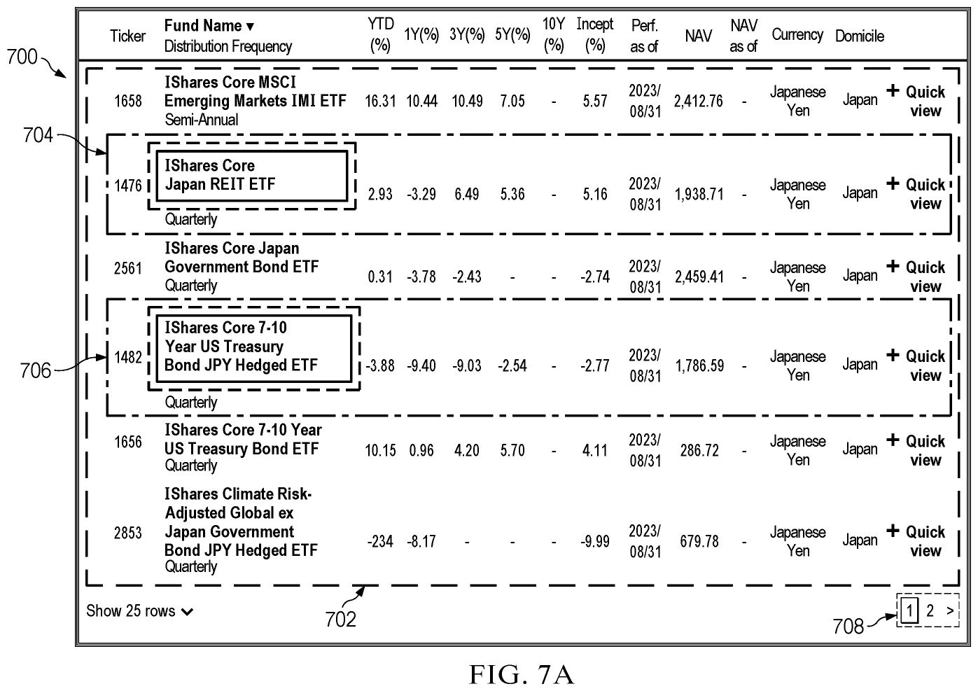

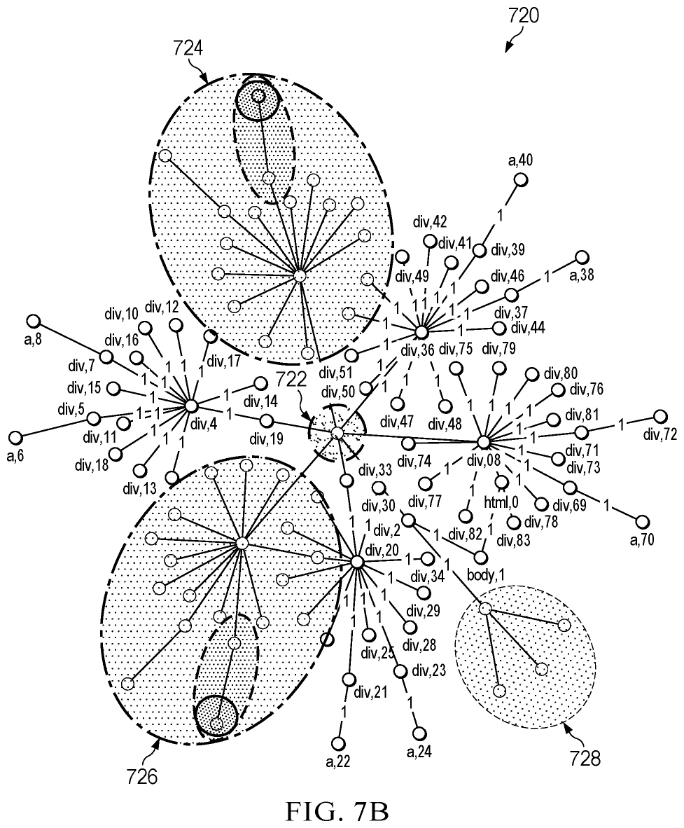

FIGS. 7A-7B illustrate another example web data extraction in accordance with illustrative embodiments. FIG. 7A shows web page 700 and a corresponding HTML graph 720 is shown in FIG. 7B. Web page 700 includes table 702 having rows 704, 706 and pagination box 708.

In graph 720, root node 722 represents table 702. Sub-graph 724 represents row 704, and sub-graph 726 represents row 706. Sub-graph 728 represents pagination box 708. In sub-graph 728, pagination box and page numbers are represented by list nodes <ul> and list elements <li>. Because sub-graphs 724 and 726 represent rows, they have similar structures. By analyzing sub-graph 724, similar sub-structures such as sub-graph 726 can be identified.

Although, web page 700 shows table 702, the corresponding graph 720 does not contain table tags <table> because the developer of web page 700 opted to use division tags <div> and anchor tags <a> instead of using table tags <table> to construct table 702. Due to the flexible nature of HTML syntax, which allows variations, division and anchor tags can be used instead of table tags to construct a table on web page 700.

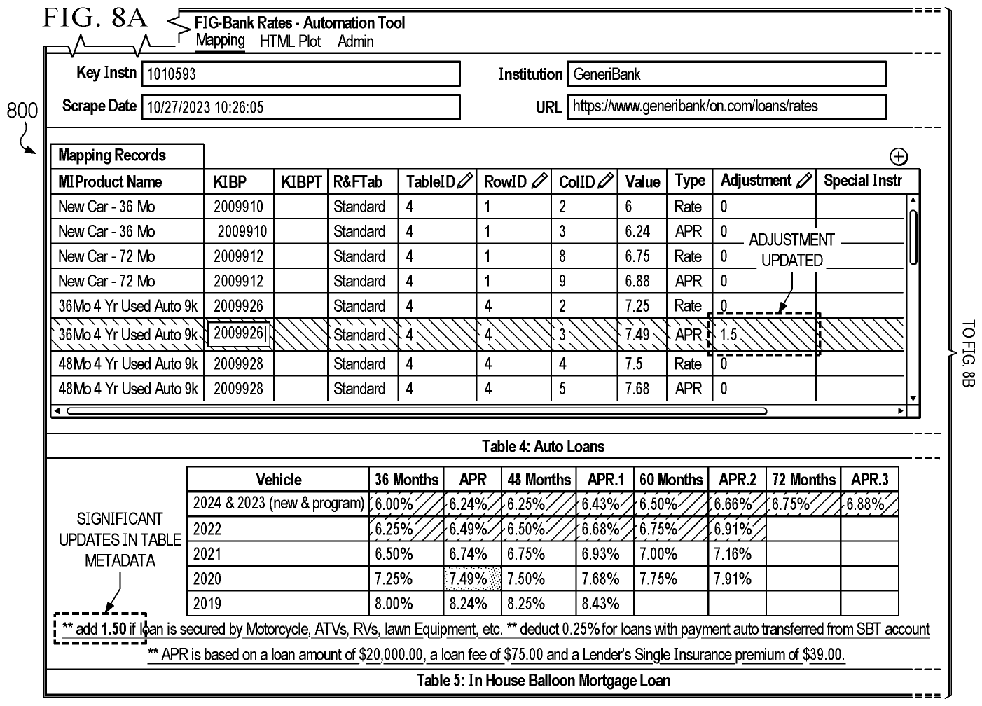

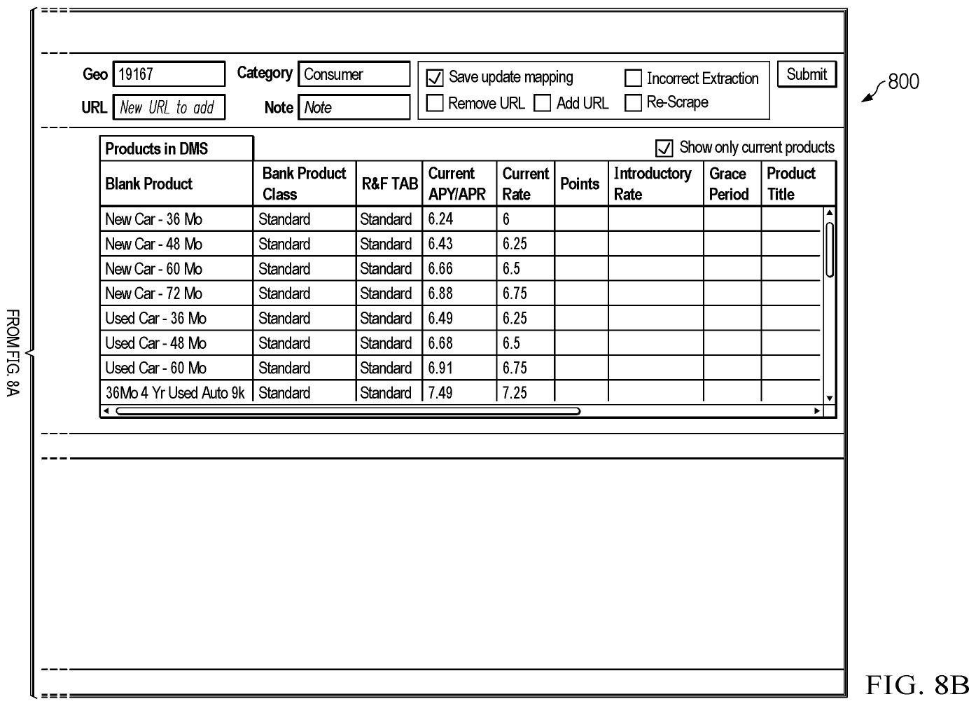

FIGS. 8A-8B illustrate user interface 800 showing data extracted from a web page and detection of significant changes. User interface 800 shares insight from significant change detection with users. Extracted items from an HTML graph are displayed in mapping records, and extracted tables and corresponding metadata are presented in a bottom pane. The location of extracted items is highlighted in the table pane. Any significant changes found in non-tabular metadata content are highlighted for user's analysis. A user interprets the changes and adds appropriate updates to the items. Feedback to a machine learning model is submitted by selecting appropriate checkboxes and clicking a Submit button.

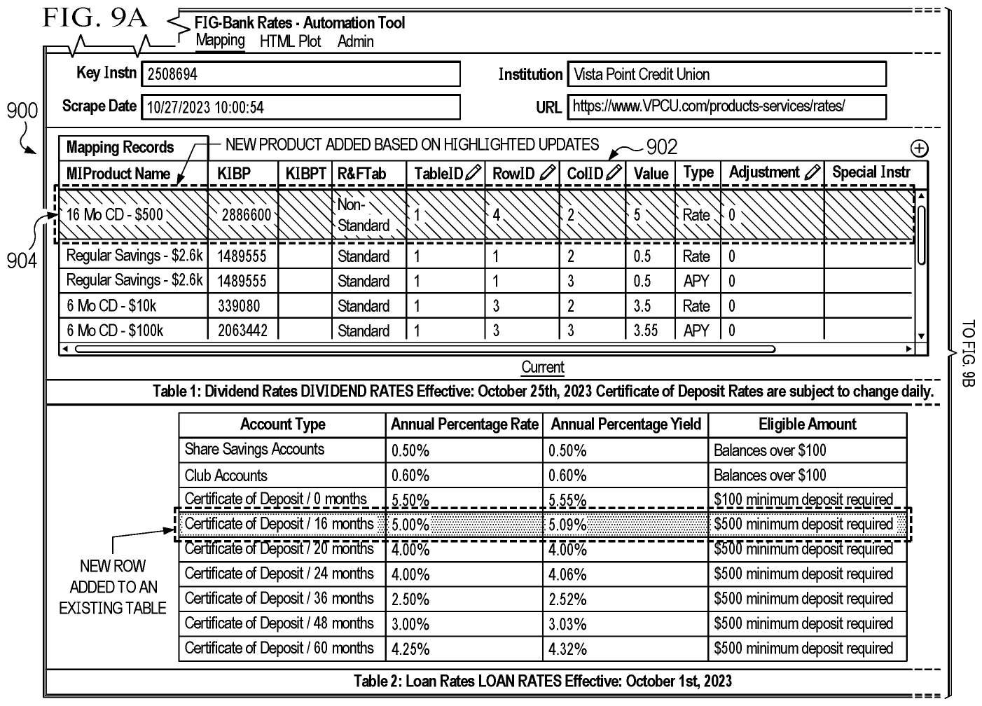

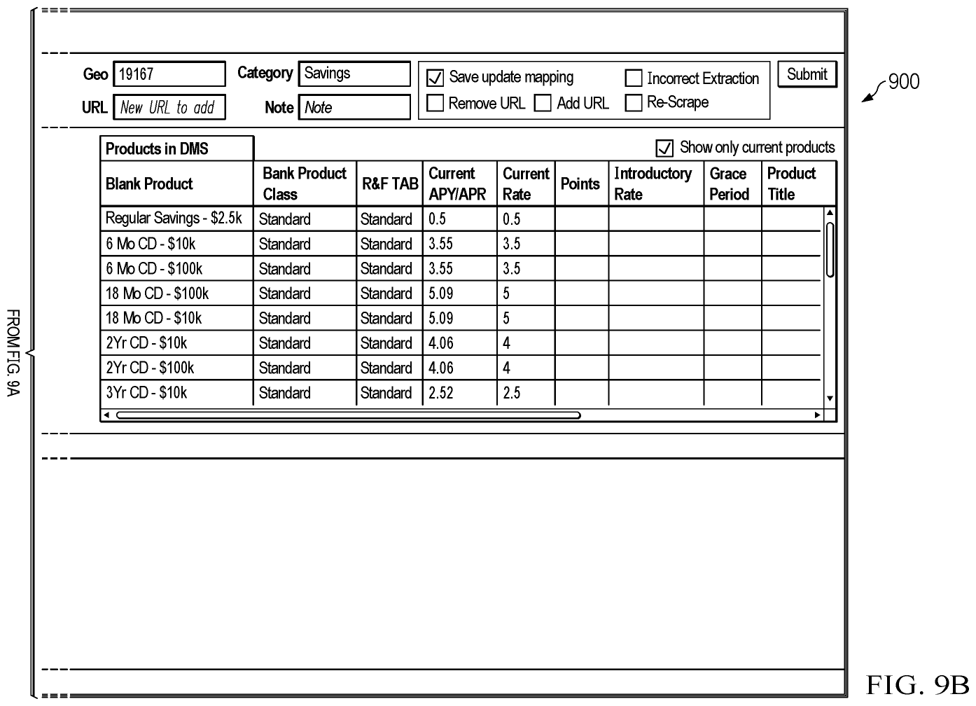

FIGS. 9A-9B illustrate user interface 900 showing data extracted from a web page and detection of new data items in table 902. In table 902, mapped items are extracted from a web page and new row 904 is added. A user can interpret this change in table 902 and add a new product to mapping records. Thus, table 902 shows previously mapped items and the new row. Feedback to a machine learning model is submitted by selecting appropriate checkboxes and clicking a Submit button.

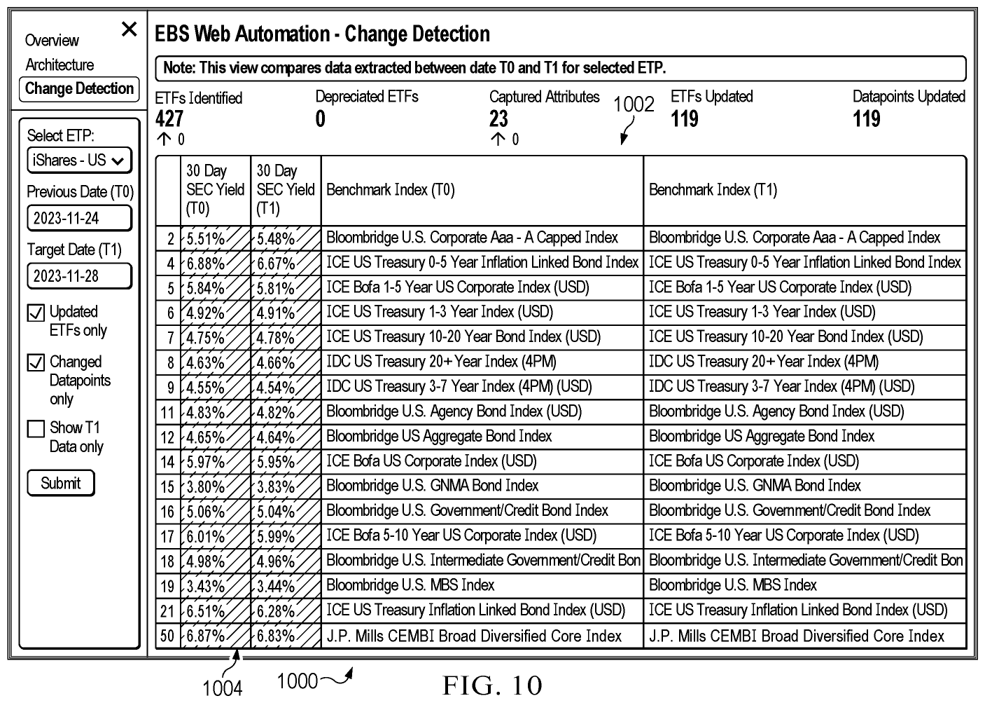

FIG. 10 illustrates user interface 1000 showing extracted data 1002 from a web page and change detection view 1002. User interface 1000 allows custom date selection for the changes. Relevant statistics and changes in the data items are highlighted. A user can validate the changes and add appropriate updates to be stored in a database as feedback. A user can highlight any incorrect extraction submit feedback to the machine learning model by selecting appropriate checkboxes and clicking a Submit button.

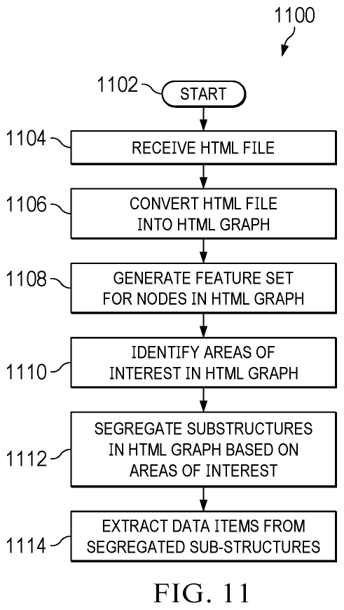

With reference next to FIG. 11, a flowchart of process 1100 for a computer-implemented method for web data extraction is provided. Process begins at step 1102. An HTML file containing HTML data is received (step 1104). The HTML data is converted into an HTML graph by an HTML graph extractor (step 1106). In the HTML graph, elements in the HTML file are represented by nodes and relationships among the elements are represented by meta-paths.

Next, a feature set for the nodes in the HTML graph are generated by a feature extractor (step 1108). The feature set may be represented by vectors which may include: (1) location/position vectors (e.g., coordinates or relative positions); (2) content vectors (e.g., embeddings representing text content); and (3) property vectors (e.g., attributes from HTML/CSS). In some embodiments, the vectors are represented by N bits of binary values.

Next, areas of interest in the HTML graph are identified by an area of interest (AOI) identifier based on the feature set of the nodes (step 1110). The identified areas of interest are then refined by a sub-structure analyzer by segregating or isolating sub-structures having recurring patterns or sequences (step 1112). Next, data items from the segregated or isolated sub-structures are extracted by a data extractor and stored in a standardized format (step 1114). The extracted data items are standardized and stored, for example, as key-value pairs, tabular content (e.g., headers, table, footers) and pagination (e.g., URLs).

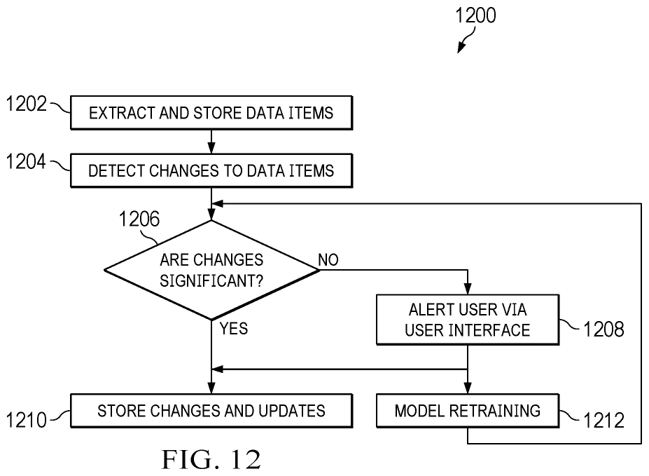

With reference next to FIG. 12, a flowchart of process 1200 for detecting changes or updates to web pages is provided. Data items from segregated and or isolated sub-structures are extracted and stored by a data extractor (step 1202). Next, a change detector identifies changes and updates to the web pages based on user defined logic and feedback (step 1204). In some embodiments, the change detector detects changes or updates to the web pages by detecting changes or updates to the segregated or isolated sub-structures. In some embodiments, the change detector detects changes or updates to the web pages by detecting changes of updates in the extracted and stored data items.

In decision block 1206, if changes or updates to the web pages are determined to be significant, users are alerted via a user interface (step 1208) for feedback on the changes, and the changes and updates are stored in a database (step 1210). Based on user feedback, a machine learning model is trained to form a new trained model object (step 1212). The trained model object represents a mapping function which makes predictions or decisions on new or unseen sub-structures or data in the HTML graph. If there are no significant changes or updates present, the data is stored in the database (step 1214).

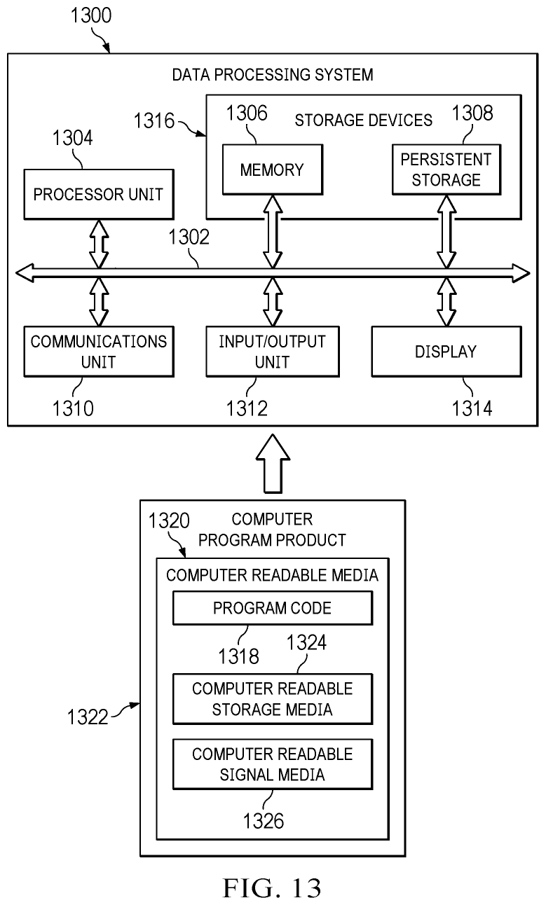

Turning now to FIG. 13, an illustration of a block diagram of a data processing system is depicted in accordance with an illustrative embodiment. Data processing system 1300 may be used to implement server computers 104 and 106 and client devices 110 in FIG. 1, as well as computer system 200 in FIG. 2. In this illustrative example, data processing system 1300 includes communications framework 1302, which provides communications between processor unit 1304, memory 1306, persistent storage 1308, communications unit 1310, input/output unit 1312, and display 1314. In this example, communications framework 1302 may take the form of a bus system.

Processor unit 1304 serves to execute instructions for software that may be loaded into memory 1106. Processor unit 1304 may be a number of processors, a multi-processor core, or some other type of processor, depending on the particular implementation. In an embodiment, processor unit 1304 comprises one or more conventional general-purpose central processing units (CPUs). In an alternate embodiment, processor unit 1304 comprises one or more graphical processing units (GPUS).

Memory 1306 and persistent storage 1308 are examples of storage devices 1316. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1316 may also be referred to as computer-readable storage devices in these illustrative examples. Memory 1306, in these examples, may be, for example, a random access memory or any other suitable volatile or non-volatile storage device. Persistent storage 1308 may take various forms, depending on the particular implementation.

For example, persistent storage 1308 may contain one or more components or devices. For example, persistent storage 1308 may be a hard drive, a flash memory, a rewritable optical disk, a rewritable magnetic tape, or some combination of the above. The media used by persistent storage 1308 also may be removable. For example, a removable hard drive may be used for persistent storage 1308. Communications unit 1310, in these illustrative examples, provides for communications with other data processing systems or devices. In these illustrative examples, communications unit 1310 is a network interface card.

Input/output unit 1312 allows for input and output of data with other devices that may be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating systems, applications, or programs may be located in storage devices 1316, which are in communication with processor unit 1304 through communications framework 1302. The processes of the different embodiments may be performed by processor unit 1304 using computer-implemented instructions, which may be located in a memory, such as memory 1306.

These instructions are referred to as program code, computer-usable program code, or computer-readable program code that may be read and executed by a processor in processor unit 1304. The program code in the different embodiments may be embodied on different physical or computer-readable storage media, such as memory 1306 or persistent storage 1308.

Program code 1318 is located in a functional form on computer-readable media 1320 that is selectively removable and may be loaded onto or transferred to data processing system 1300 for execution by processor unit 1104. Program code 1318 and computer-readable media 1320 form computer program product 1322 in these illustrative examples. In one example, computer-readable media 1320 may be computer-readable storage media 1324 or computer-readable signal media 1326.

In these illustrative examples, computer-readable storage media 1324 is a physical or tangible storage device used to store program code 1318 rather than a medium that propagates or transmits program code 1318. Computer readable storage media 1324, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1318 may be transferred to data processing system 1300 using computer-readable signal media 1326. Computer-readable signal media 1326 may be, for example, a propagated data signal containing program code 1318. For example, computer-readable signal media 1326 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1300 are not meant to provide architectural limitations to the manner in which different embodiments may be implemented. The different illustrative embodiments may be implemented in a data processing system including components in addition to or in place of those illustrated for data processing system 1100. Other components shown in FIG. 13 can be varied from the illustrative examples shown. The different embodiments may be implemented using any hardware device or system capable of running program code 1318.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for web data extraction, comprising:
receiving an HTML file containing HTML data;
converting the HTML data into an HTML graph, wherein elements in the HTML file are represented by nodes in the HTML graph and relationships among the elements are represented by meta-paths;
generating feature sets for the nodes in the HTML graph;
identifying areas of interest in the HTML graph based on the feature sets of the nodes;
refining the identified areas of interest by segregating sub-structures having recurring patterns or sequences; and
extracting data items from the segregated sub-structures and storing the extracted data items.

2. The method of claim 1, wherein the feature sets are represented by vectors, and wherein the vectors include one or more of:
location or position vectors;
content vectors;
property features; and
domain specific vectors.

3. The method of claim 1, further comprising detecting changes to web pages by detecting changes to the extracted data items from the segregated sub-structures, wherein the changes to the web pages are modifications or updates to the web pages.

4. The method of claim 1, wherein the extracted data items are standardized and stored as one or more of:
key-value pairs;
tabular content; and
pagination.

5. The method of claim 1, further comprising identifying the areas of interest in the HTML graph using input from users to infer probable regions or nodes that are of interest.

6. The method of claim 1, further comprising:
determining if the changes to web pages are significant changes; and
if there are significant changes, notifying users via a user interface.

7. The method of claim 6, further comprising:
training a machine learning model using the significant changes to form a trained model object; and
segregating the sub-structures using the trained model object.

8. The method of claim 2, wherein the location or position vectors comprise coordinates or relative positions of nodes in the HTML graph.

9. The method of claim 2, wherein the content vectors comprise embeddings representing text content of nodes in the HTML graph.

10. The method of claim 2, wherein the property vectors comprise attributes extracted from the nodes in the HTML graph.

11. A system for web data extraction, the system comprising:
a storage device configured to store program instructions; and
one or more processors operably connected to the storage device and configured to execute the program instructions to cause the system to:
receive an HTML file containing HTML data;
convert the HTML data into an HTML graph, wherein elements in the HTML file are represented by nodes in the HTML graph and relationships among the elements are represented by meta-paths;
generate feature sets for the nodes in the HTML graph;
identify areas of interest in the HTML graph based on the feature sets of the nodes;
refine the identified areas of interest by segregating sub-structures having recurring patterns or sequences; and
extract data items from the segregated sub-structures and store the extracted data items.

12. The system of claim 11, wherein the processors further execute instructions to represent the feature sets by vectors, and wherein the vectors include one or more of:
location or position vectors;
content vectors;
property vectors; and
domain specific vectors.

13. The system of claim 11, wherein the processors further execute instructions to detect changes to web pages by detecting changes to the extracted data items from the segregated sub-structures, wherein the changes to the web pages are modifications or updates in the web pages.

14. The system of claim 11, wherein the processors further execute instructions to standardize and store the extracted data items as one or more of:
key-value pairs;
tabular content; and
pagination.

15. The system of claim 11, wherein the processors further execute instructions to identify the areas of interest in the HTML graph using input from users to infer probable regions or nodes that are of interest to an organization.

16. The system of claim 11, wherein the processors further execute instructions to:
determine if the changes to web pages are significant changes; and
if there are significant changes, notify users via a user interface.

17. The system of claim 16, wherein the processors further execute instructions to:
train a machine learning model using the significant changes to form a trained model object; and
segregate the sub-structures using the trained model object.

18. A computer program product for web data extraction, the computer program product comprising:
a computer-readable storage medium having program instructions embodied thereon to perform the steps of:
receiving an HTML file containing HTML data;
converting the HTML data into an HTML graph, wherein elements in the HTML file are represented by nodes in the HTML graph and relationships among the elements are represented by meta-paths;
generating feature sets for the nodes in the HTML graph;
identifying areas of interest in the HTML graph based on the feature sets of the nodes;
refining the identified areas of interest by segregating sub-structures having recurring patterns or sequences; and
extracting data items from the segregated sub-structures and storing the extracted data items.

19. The computer program product of claim 18, further comprising instructions for detecting changes to web pages by detecting changes to the extracted data items, wherein the changes to the web pages are modifications or updates in the web pages.

20. The computer program product of claim 18, wherein the feature sets are represented by vectors, and wherein the vectors include one or more of:
location or position vectors;
content vectors;
property vectors; and
domain specific vectors.

21. The computer program product of claim 18, wherein the extracted data items are standardized and stored as one or more of:
key-value pairs;
tabular content; and
pagination.

22. The computer program product of claim 18, further comprising instructions for identifying the areas of interest in the HTML graph using input from users to infer probable regions or nodes that are of interest to an organization.

23. The computer program product of claim 19, further comprising instructions for determining:
if the changes to web pages are significant changes; and
if there are significant changes, notifying users via a user interface.

24. The computer program product of claim 18, further comprising instructions for:
training a machine learning model using the significant changes to form a trained model object; and
segregating the sub-structures using the trained model object.
